(19) United States
(12) Patent Application Publication
(10) Pub. No.: US 2016/0229092 A1
(43) Pub. Date: Aug. 11, 2016

(54) TEXTURED FILM ON SUBSTRATE

(71) Applicant: HEWLETT-PACKARD DEVELOPMENT COMPANY, L.P., Houston, TX (US)

(72) Inventors: CHUNG-HUNG HUANG, TAIPEI CITY (TW); KUAN-TING WU, TAIPEI CITY (TW)

(21) Appl. No.: 15/021,487

(22) PCT Filed: Oct. 31, 2013
(86) PCT No.: PCT/US2013/067692

§ 371 Date: Mar. 11, 2016

(51) Int. Cl. B29C 43/02; B29C 33/42; B29C 43/20; B29C 43/36; B29C 43/52; B29C 43/18

(52) U.S. Cl. CPC B29C 43/021; B29C 43/52; B29C 43/18; B29C 43/203; B29C 43/36; B29C 33/424; B29K 2995/0074; B29L 2031/3481

(57) ABSTRACT

A method of molding is described in which a film and a substrate are positioned between first and second mold parts. The first mold part is compressed against the film and the second mold part is compressed against the substrate to form the film and substrate into a molded product. The compressing forms a texture in a surface of the film.

### BACKGROUND

During in-mold decoration (IMD), a textured film can be located in a plastic injection mold. Plastic resin is injected into the mold, fixing the film in the molded product.

Using out-side mold decoration (OMD), a molded part is formed and then a textured film can be transferred onto the molded part to form a molded product.

### BRIEF DESCRIPTION OF DRAWINGS

By way of non-limiting examples, methods and apparatus according to the present disclosure are described with reference to the following drawings, in which:

FIGS. 1a to 1e illustrate an example method of molding according to the present disclosure;

FIGS. 2a to 2c illustrate another example method of molding according to the present disclosure;

FIGS. 3a to 3c illustrate yet another example method of molding according to the present disclosure;

FIGS. 4a to 4c illustrate another example method of molding according to the present disclosure;

FIG. 5 illustrates yet another example method of molding according to the present disclosure;

FIG. 6 illustrates another example method of molding according to the present disclosure;

FIG. 7 illustrates an alternative example of a preform that may be used in example methods of molding according to the present disclosure;

FIG. 8 illustrates another example method of molding according to the present disclosure;

FIG. 9 illustrates yet another example method of molding according to the present disclosure; and

FIGS. 10a to 10c illustrate another example method of molding according to the present disclosure.

### DESCRIPTION OF EXAMPLES

In some examples disclosed herein, as film and a substrate are positioned between first and second mold parts. The first mold part is compressed against the film and the second mold part is compressed against the substrate to form the film and substrate into a molded product. The compressing forms a texture in a surface of the film. The compressing can also change the shape of the substrate. In some examples disclosed herein, a substrate having film connected to the substrate is compressed, wherein the compressing shapes the substrate and forms a texture in a surface of the film substantially at the same time. In some examples disclosed herein, molding apparatus includes a first mold part and a second mold part. The first and second mold parts are adapted to receive a film and a substrate therebetween and compress the film and the substrate to form a molded product. The first mold part includes a texture mold form such that, when the first and second mold parts compress the film and the substrate, a texture is formed in a surface of the film by the texture mold form. The second mold part can include a shape mold form such that, when the first and second mold parts compress the film and the substrate, a shape is formed in the substrate.

In some examples disclosed herein, by forming a texture in a surface of a film substantially at the same time as forming a molded product, the number of processing steps required to form a finished product may be reduced, a shorter production cycle time may be achieved and/or production costs may be lowered.

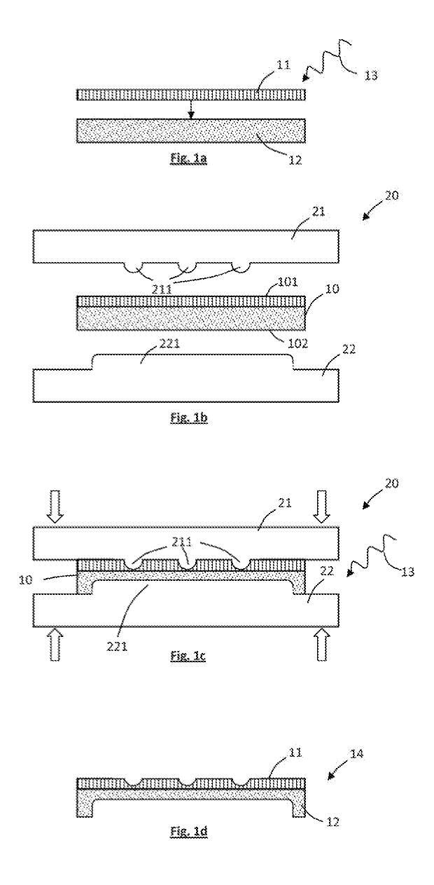

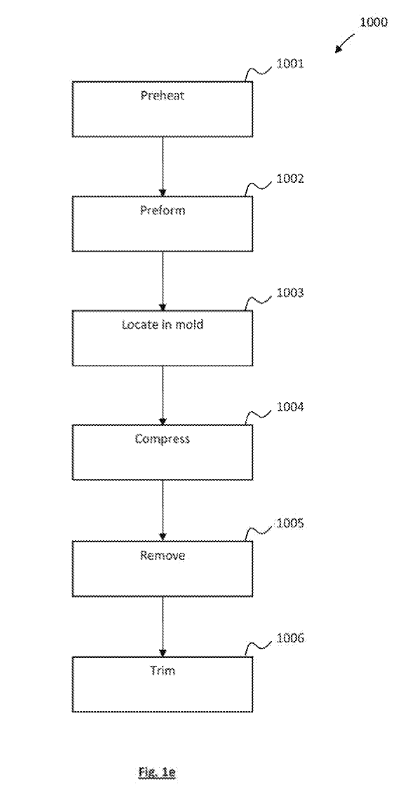

FIGS. 1a to 1e illustrate an example method of molding according to the present disclosure. With reference to FIG. 1a, as part of a pre-heating stage, heat 13 is applied to a film 11. Pre-heating of the film may be at a temperature of between about 80 to 300° C., for example. During or immediately after pre-heating, the film 11 is brought into contact with a surface of a substrate 12 to form a preform 10. The preform 10 therefore includes a layer of film 11 at a first side 101 and a layer of substrate 12 at a second side 102. By pre-heating the film 11, flexibility and/or adhesive properties of the film 11 can be increased to provide a reliable engagement between the film 11 and the substrate 12.

Next, with reference to FIG. 1b, the preform 10 is located between first and second mold parts 21, 22 of a compression mold 20, with the first side 101 of the perform 10 facing the first mold part 21 and the second side 102 of the preform 10 facing the second mold part 22. The first mold part 21 includes a texture mold form, represented by protrusions 211, and the second mold part 22 includes a shape mold form 221.

Subsequently, with reference to FIG. 1e, pressure is applied to one or both of the mold parts 21, 22 such as to press the mold parts 21, 22 towards each other and compress the preform 10 therebetween. Mechanical pressure and/or vacuum pressure may be applied, for example. Immediately before and/or during the compression, heat 13 can be applied to the preform 10. Heating of the preform 10 may be at a temperature of between about 80 to 300° C., for example. By applying pressure, or by applying pressure and heating, the film and the substrate may be fixed together, e.g., substantially fused and/or irremovably connected together.

During compression, the texture mold form 211 is adapted to press into the film 11 in order to mold a corresponding (negative) texture in the film 11 and, substantially at the same time, the shape mold form 221 is adapted to press into the substrate 12 in order to mold a corresponding (negative) shape in the substrate 12. The compression results in formation of a molded product 14 as represented in FIG. 1d in this example. To assist with removal of the molded product 14 from the mold 20, heat may be applied to the mold 20 and/or molded product 14. The molded product 14 may be trimmed, e.g., using a laser cutting or a computer numerical control (CNC) process.

A flowchart representing the method described above with reference to FIGS. 1a to 1d is illustrated in FIG. 1e, and is designated generally by reference numeral 1000. At 1001, the film is preheated. At 1002, the film is brought into contact with a surface of the substrate to form a preform. At 1003, the preform is located in the mold. At 1004, during or after heating, pressure is applied to the preform by the mold to form a molded product with texture in the film. At 1005, the molded product is removed from the mold. At 1006, the molded product is trimmed. Not all of these features are necessarily required.

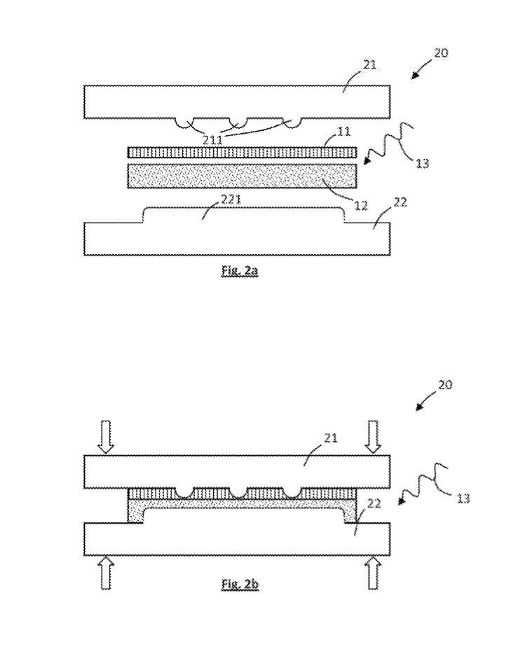

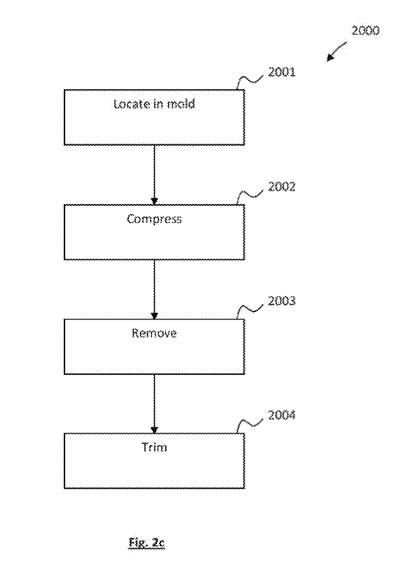

FIGS. 2a to 2c illustrate a modification to the method described above with reference to FIGS. 1a to 1e. In this modified example, a preform is not formed prior to insertion of the film 11 and the substrate 12 into the mold. Rather, the film 11 and substrate 12 are independently inserted into the mold 20 as represented in FIG. 2a, and engagement between the film 11 and the substrate 12 takes place through the application of pressure by the first and second mold parts 21, 22 during the compression molding process as represented in FIG. 2b.

A flowchart representing the method described above with reference to FIGS. 2a and 2b is illustrated in FIG. 2c, and is designated generally by reference numeral 2000. At 2001, the film and the substrate are located in the mold. At 2002, during or after heating pressure is applied to the film and the substrate by the mold to form a molded product with texture in the film. At 2003, the molded product is removed from the mold. At 2004, the molded product is trimmed. Not all of these features are necessarily required.

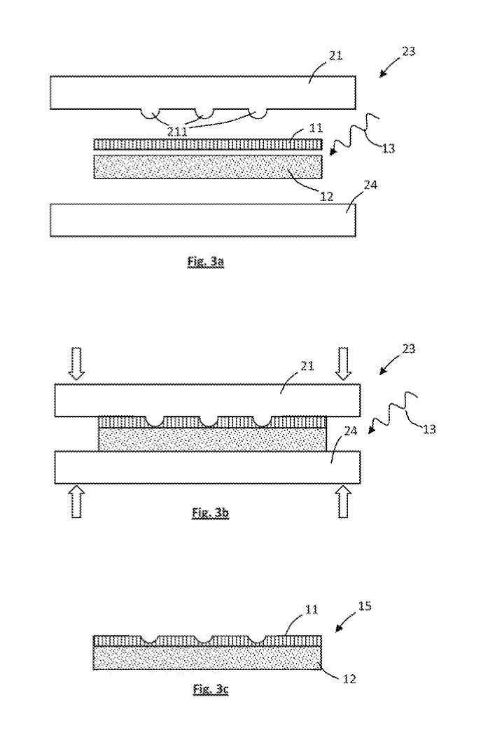

FIGS. 3a to 3c illustrate yet another modification to the method described above with reference to FIGS. 1a to 1e. In this modified example, again preform is not formed prior to insertion of the film 11 and the substrate 12 into a mold 23 as represented in FIG. 3a. Further, a second mold part 24 is provided that does not include a shape mold form in this instance. Rather, the mold 23 is adapted to fix the film 11 to the substrate 12 as part of the compression molding process as represented in FIG. 3b, and than the texture in the film 11, but provide substantially no reshaping of the substrate 12, in order to provide a molded product 15 as represented in FIG. 3c.

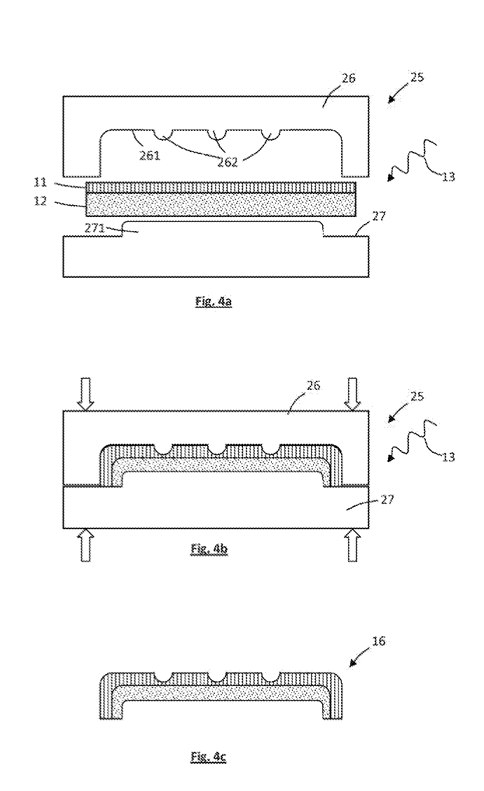

FIGS. 4a to 4c illustrate another modification to the method described above with reference to FIGS. 1a to 1e. In this modified example, a mold 25 is provided that includes first and second mold parts 26, 27 that both have shape mold forms. In particular, as can be seen in FIG. 4a, the first mold span 26 is provided with a recessed shape mold form 261, in addition to a texture mold form 262, and the second mold 27 is provided with the a protecting mold form 271. In this example, during compression as represented in FIG. 4b, both the film 11 and the substrate 12 are substantially re-shaped by the mold 25, and a texture is formed in the surface of the film, resulting to a molded product 16 as represented in FIG. 4c.

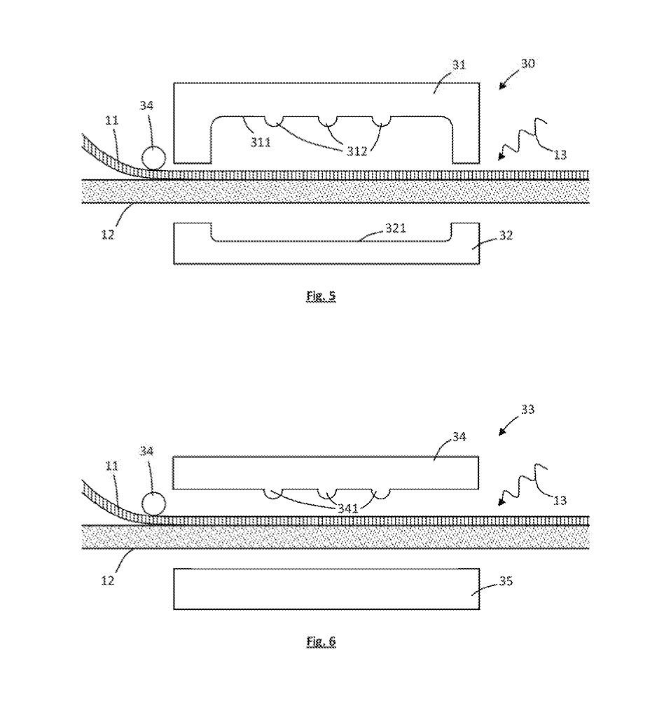

FIGS. 5 and 6 illustrate examples in which a continuous production process is used to form a molded product. Similar molding techniques may be used as described with reference to previous examples. For example, in FIG. 5, a mold 30 is provided having first and second mold parts 31, 32 (e.g. a core mold 31 and a cavity mold 32), which are arranged to press either side of the film 11 and substrate 12. The first and second mold parts 31, 32 each included shape mold forms 311, 321 and the first mold part 31 includes a texture mold form 312. In FIG. 6, a mold 33 is provided having first and second mold parts 34, 35, which are arranged to press either side of the film 11 and substrate 12. The first mold part 34 includes a texture mold form 341. In these examples, the film 11 and substrate 12 are introduced into the mold 30, 33 by a continuous feed system 34. Accordingly, a continuous manufacturing process can be applied, e.g., in contrast to a batch manufacturing process.

FIG. 7 illustrates another example of a preform 17 according to the present disclosure. In this example, the preform 17 includes a film 11, a substrate 12 and a bonding layer 18 between the film 11 and substrate 12. The bonding layer 18 is adapted to enhance interfacial bonding between the film 11 and the substrate 12. The bonding layer 18 may include an adhesive or thermoplastic resin film, for example. As part of a pre-heating step, heat 13 may be applied to the film 11, substrate 12 and/or bonding layer 18, e.g., at a temperature of between about 80 to 300° C., to further enhance engagement and bonding between these elements. The preform may be located in a mold and molded in accordance with methods discussed above, e.g., with reference to FIGS. 1b and 1c, or FIGS. 4a and 4b.

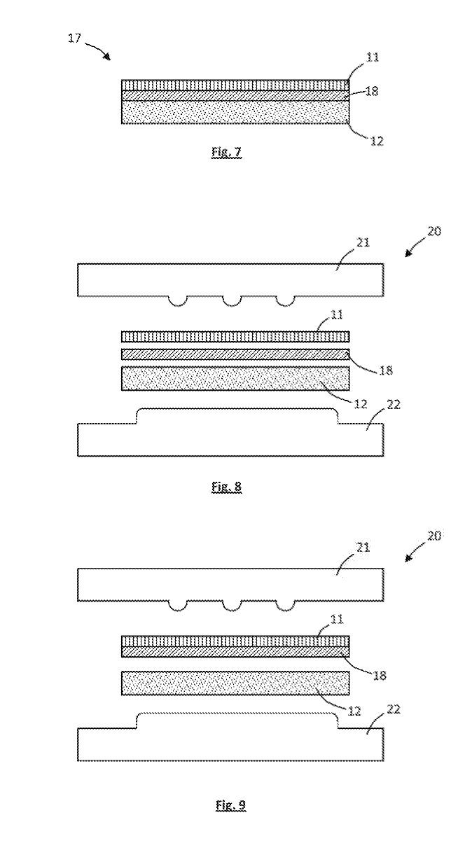

In an alternative example, the preform 17 may not be formed prior to location of the film 11, substrate 12 and bonding layer 18 into the mold. For example, the film 11, substrate 12 and bonding layer 18 may be independently inserted into a mold 20 as illustrated in FIG. 8, and engagement between the film 11 and the substrate 12 can take place through the application of pressure by the first and second mold parts 21, 22. Alternatively, as illustrated in FIG. 9, the bonding layer 18 may be engaged with only one of the film 11 and the substrate 12, prior to location in the mold 20. In this instance, engagement between the substrate 12 and the already-engaged film 11 and building layer 18, or between the film 11 and the already-engaged bonding layer 18 and substrate 12, can take place through the application of pressure by the first and second mold parts 21, 22.

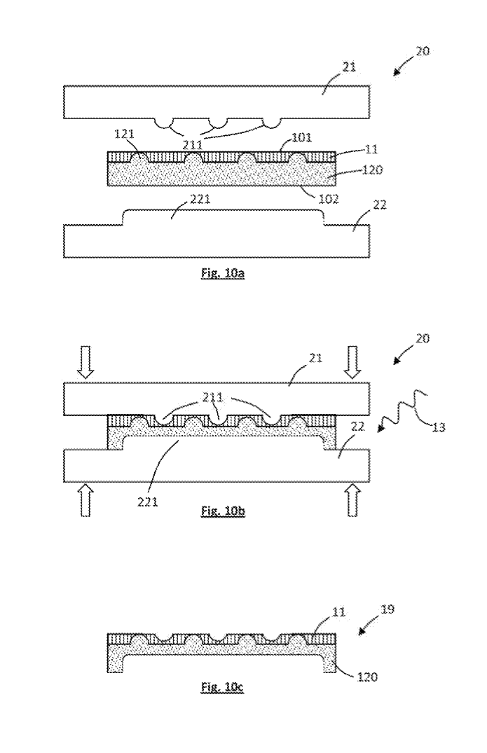

FIGS. 10a to 10c illustrate another modification to the method described above with reference to FIGS. 1a to 1e. In this modified example, a substrate 120 is provided that includes a textured surface 121. The textured surface 121 may have been formed by molding of the substrate.

The film 11 is configured to locate on a side of the substrate 120 that has the textured surface 121. The texture of the textured surface 121 of the substrate 120 may have a similar or identical scale, shape, pattern and/or depth to the texture of the textured surface formed in the film 11. The textured surface 121 of the substrate 120 is formed prior to locating the film 11 and the substrate 120 in the mold 20. The film 11 and the substrate 120 can be connected together as a preform prior to location in the mold 20 as represented in FIG. 10a, or located at the mold 20 separately. Molding of the film 11 and substrate 120 to form a molded product with a film 11 having a textured surface can take place as represented in FIG. 10b, and substantially in accordance with previous discussions. A bonding layer may be used between the film 11 and substrate 120 e.g. as described with reference to FIG. 7, 8 or 9.

By providing the substrate 120 with a textured surface 121, a molded product 19 can be formed as represented in FIG. 10c, in which texture is provided in both the film 11 and the substrate 120. This may modify a visual effect provided at a surface of the molded product. For example, it may be beneficial to a pattern design and/or may enhance a metal-like effect (e.g., metal luster). The film 11 may be transparent or see-through to some extent.

While in the examples described, the texture mold forms are illustrated using conspicuous protrusions 211, 262, 312, 341, in practice a texture mold form, and the texture formed in the film by the texture mold form, may be hard to see or invisible with the naked eye. This may contrast with the shape mold forms 221, 271, 311, 321, and the shapes formed in the substrates by the shape mold forms, which may be clearly visible to the naked eye. In some examples, the shape formed in the substrate may be considered macroscopic and the texture formed in the film may be considered microscopic, or otherwise.

Further, while the film 11 is illustrated in the Figures as having a reasonably similar thickness to the substrate 12, 120, in practice the film 11 may have a thickness that is significantly shorter than the thickness of the substrate 12, 120. For example, the film 11 may have a thickness that is less than 50%, less than 20%, less than 10%, less than 5% less than 2% or otherwise, of the thickness of the substrate 12, 120.

Further, the thickness of the texture mold form, and/or the depth of portion of the texture mold form that is configured to press into the film 11, may be configured to be shorter than the thickness of the film 11. Accordingly, exposure of the substrate 12, 120 through the film 11 may be prevented during the molding process.

In the examples, the texture in the film 11 formed by the molding may include a pattern, an array, letters, numbers, symbols and/or other features. The molded texture in the film 11 may provide for decoration of the film and the molded product in general. The molded texture in the film 11 may provide a cosmetic and/or technical effect. For example, it may provide anti-fingerprint, antibacterial, anti-scratch, metal-like, matt, visual and/or tactual effect to a surface of the molded product.

In this and other examples, the molded product may take a variety of different shapes and configurations and be used for a variety of different applications. For example, the molded product may be a casing or part of a casing for an electrical device such as a notebook, laptop, tablet PC or smartphone, and the molded texture may provide anti-fingerprint and metal-like properties to the casing.

The film 11 may be formed of a variety of different materials. For example, the film may include polymeric material, metal, rubber, combinations thereof or otherwise.

The substrate may be formed of a variety of different materials. For example, the substrate may include metal, plastic, carbon fibers, ceramics or composites, combinations thereof or otherwise.

Throughout this specification the words “comprising”, “having” and “including” or variations such as “comprise”, “comprises, “have,” “has”, “include”, or “includes”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the above-described examples, without departing from the broad general scope of the present disclosure. For example, the molds, mold parts, texture mold forms and/or shape mold forms may take a variety of different shapes and configurations, which may differ considerably from those represented in the Figures. Further, while the substrate is illustrated in Figures as including one layer only, the substrate may include multiple layers or components. Still further, while the film is shown in Figures on one side of the substrate only, the film may be applied to more than one side and/or around the entire substrate. The present examples are, therefore, to be considered in all respects as illustrative and not restrictive.

1. A method of molding comprising:
positioning a film and a substrate between first and second mold parts;
compressing the first mold part against the film and the second mold part against the substrate to form the film and substrate into a molded product,
wherein the compressing forms a texture in a surface of the film.

2. The method of claim 1, wherein the compressing changes the shape of the substrate.

3. The method of claim 1, wherein prior to the compressing, the film is connected to the substrate 30 form a preform.

4. The method of claim 3, comprising heating the film prior to connecting the film to the substrate.

5. The method of claim 1, comprising heating the film and/or substrate during the compressing.

6. The method of claim 1, wherein the texture is a textured pattern.

7. The method of claim 1, wherein the texture provides an anti-fingerprint, antibacterial, anti-scratch, metal-like, matt, visual and/or tactual effect to the surface.

8. The method of claim 1, comprising positioning a bonding layer between the film and substrate prior to the compressing.

9. The method of claim 2, wherein a bonding layer is connected between the film and the substrate to form the preform.

10. The method of claim 1, wherein the substrate comprises a texture molded in a surface thereof.

11. The method of claim 1, wherein the molded product provides a casing or part of a casing for an electrical device.

12. A method of molding comprising:
compressing a substrate having a film connected to the substrate, wherein the compressing shapes the substrate and forms a texture in a surface of the film substantially at the same time.

13. A molded product formed by the method of claim 1.

14. Molding apparatus comprising:
a first mold part; and
a second mold part;
wherein the first and second mold parts are adapted to receive a film and a substrate therebetween and compress the film and the substrate to form a molded product, and
wherein the first mold part comprises a mixture mold form such that, when the first and second mold parts compress the film and the substrate, a texture is formed in a surface of the film by the texture mold form.

15. The apparatus of claim 14, wherein the second mold part comprises a shape mold form such that, when the first and second mold parts compress the film and the substrate, a shape is formed in the substrate.
